(19) United States
(12) Patent Application Publication
(10) Pub. No.: US 2010/0101711 A1
(43) Pub. Date: Apr. 29, 2010

(54) DEVICE AND METHOD FOR APPLYING DECORATION, WHICH ADHERES TO A FILM, TO AN OBJECT

(76) Inventor: Maximilian Zaher, Edewecht (DE)

Correspondence Address: STRAUB & POKOTYLO, 788 Shrewsbury Avenue, TINTON FALLS, NJ, 07724, US

(21) Appl. No.: 12/593,285

(22) PCT Filed: Mar. 26, 2007
(86) PCT No.: PCT/EP07/02658

§ 371 Date: Sep. 25, 2009

(51) Int. Cl. B29C 65/14; B44C 1/16

(52) U.S. Cl. 156/230; 156/499

(57) ABSTRACT

The invention relates to a device and a method for applying decoration, which adheres to a film (1), to an object (2). The device has a heating roller (7) for preheating the film (1), an adjusting roller (6), which is movable in at least two directions and arranged beside the heating roller (7), for adjusting the size of the area of contact of the film (1) with the heating roller (7), and means (9, 10) for detaching the decoration from the film (1), preheated by the heating roller (7), onto the object (2). A profiled preforming roller (8) for preforming the film is arranged beside the heating roller (7).

The present invention relates to a device and a method for applying decoration, which adheres to a film, to an object.

Films which have a so-called release property are known from the prior art, for example the patent specifications EP 0 573 676 B1 and EP 1 053 793 A1. Both papers and films which have been produced from resins and the surfaces of which have been treated such that the film or paper has release properties are known from the prior art. If a layer of lacquer or decorative layer with release properties is applied to such a film, these can be detached onto an object to be decorated.

The document EP 0 573 676 B1 discloses the use of a carrier with a release property for applying colour decoration to a substrate. For this purpose, first lacquer and optionally dyestuff is applied to a carrier with a release property. Then, a partial crosslinking of the lacquer is carried out. Subsequently, the partially crosslinked lacquer, with or without the dyestuff, is transferred to the substrate to be decorated or lacquered and complete crosslinking of the lacquer takes place.

The document EP 1 053 793 A1 discloses a process for applying lacquer and decoration to an object with the aid of a film which has a release property, an adhesive layer being applied to the lacquer and the decoration of the release film. When the layers are applied to the object, the adhesive layer is in direct contact with the object.

A device for applying decoration, which adheres to a film, to an object with the aid of the release technique is also known from the prior art.

However, the known devices have the disadvantage that the film can pass through merely at a speed of 5 metres per minute, so that no creasing and/or shrinkage of the film occurs and the decoration can be detached from the film and applied to the object as intended.

Against this background, it is an object of the present invention to provide a device and a method for applying decoration, which adheres to a film, to an object which enable a high throughput speed of the film through the device without the film creasing, blistering or shrinking.

This object is achieved by a device of the type referred to at the outset which has a heating roller for preheating the film, an adjusting roller, which is movable at least in two directions and arranged beside the heating roller, for adjusting the size of the area of contact of the film with the heating roller, and means for detaching the decoration from the film, preheated by the heating roller, onto the object.

The processing speed of the film, i.e. the throughput speed of the film through the device, depends inter alia on the area of contact of the film with the heating roller and the level of the temperature at which the decoration is detached from the film. In principle, it can be assumed that the greater the area of contact of the film with the heating roller, the quicker the film can run over the heating roller. If only a small contact area is present between heating roller and film, the film should also pass the heating roller at only a low speed. Moreover, the level of the temperature of the heating roller also influences the throughput speed. Higher temperatures enable higher throughput speeds.

In an advantageous embodiment variant of the invention, the heating roller delivers a constant temperature to the film. Preferably, the heating roller has a temperature of 120 to 240° C. Depending on the material of the object to be printed, favourable results have been achieved with regard to the release technique at 140° C. for a plastic object, at 180° C. for a wood material, at 240° C. for metal and at 200° C. for composite materials, e.g. wood and plastic. At the above-mentioned temperatures, the decoration can be advantageously detached from the film even at high throughput speeds.

The heating roller is to deliver as far as possible a constant temperature to the film. Since oil can vary its temperature only very slowly, in a preferred embodiment of the invention hot oil is used to heat the heating roller.

The movability of the adjusting roller is not restricted to two directions. It is also is conceivable to enable a movability of the adjusting roller in four directions in a plane. What is important here is that the movable adjusting roller can be adjusted in such a way that the size of the area of contact of the film with the heating roller is variable. It is thus possible, depending on the temperature of the heating roller and the position of the adjusting roller, to optimally adjust the device such that a high throughput speed of the film through the device is made possible. This provides economic advantages for the operator of the device.

The means for detaching the decoration from the film, preheated by the heating roller, onto the object preferably employ the so-called release technique. The release technique has the advantage that no adhesive is necessary for applying the decoration to the object.

The object stated at the outset is also achieved by a device of the type referred to at the outset which has a heating roller for preheating the film, a profiled so preforming roller, arranged beside the heating roller, for preforming the film, and means for detaching the decoration from the film, preformed by the profiled preforming roller, onto the object.

The profiled preforming roller is designed at the surface with a negative profile of the surface of the object. The preforming roller is arranged, in the direction of the film running through the device, after the heating roller. With the aid of the preforming roller, the film is prepared for the release process, so that the film does not crease or blister or shrink even at high throughput speeds.

According to a preferred embodiment of the invention, the preforming roller is designed so as to be movable in at least two directions. It is thereby possible for the preforming roller to bring the film into contact with, or keep it in contact with, the object in a flexible manner and thus avoid creasing of the film.

According to a development of the present invention, the preforming roller consists of silicone foam at least at its surface. Silicone foam has the properties of a high sealing ability, a high thermal insulation ability and a virtually unchanged property structure over a large temperature range. Consequently, silicone foam is preferably suited to bringing the heated film into contact with the object and preparing it for the release process.

With regard to the means for detaching the decoration, an advantageous embodiment variant of the invention provides that these means have a profiled detaching roller for detaching the decoration from the film onto the object and means for heating the detaching roller. With the aid of the profiled detaching roller, the decoration is detached from the film with the aid of the release technique and applied to the object. For the release technique, it is necessary for the detaching roller to be heated.

According to an advantageous development of the invention, in the case of the means for heating the detaching roller the temperature is variably adjustable. In particular, a quick temperature change is to be possible if a change of the film is to be made with objects to be printed which remain the same.

According to a preferred embodiment of the invention, the means for heating the detaching roller have at least one infrared radiator. A heating of the detaching roller by means of at least one infrared radiator has the advantage over known heating methods, for example a heating with the aid of circulating air, that less energy is required.

Preferably, the at least one infrared radiator produces a temperature of 80° C. to 240° C. The detaching roller is thus irradiated at a temperature of 80° C. to 240° C.

In the case of an advantageous embodiment of the invention, it is further provided that the means for heating tie detaching roller are arranged over an area of the surface of the detaching roller which is defined by a circular arc of the detaching roller with a central angle of at least 160° and the width of the detaching roller. In the case of the embodiment in which the means for heating the detaching roller are formed by infrared radiators, this would mean that a plurality of infrared radiators are arranged over the surface of the detaching roller. It is, however, also conceivable to use a single circular infrared radiator. In principle, it can be said that the greater the surface of the detaching roller irradiated by the means for heating the detaching roller, the better are the results achieved in the case of the release technique. Good results with regard to the release technique have been achieved with a central angle of at least 160°, preferably 180°.

According to a preferred embodiment of the invention, the detaching roller consists of silicone at least at the surface. Silicone has the property of being heat-resistant and yet having a high stiffness, in particular a higher stiffness than silicone foam for example. For this reason, silicone is preferably suited to absorbing the heat from the means for heating the detaching roller and, as a result of pressure, releasing the decoration from the film with the aid of the release technique and applying it to the object.

According to an advantageous embodiment of the invention, the device has a drive roller. The rotational speed of the drive roller is adjustable, so that the throughput speed of the film through the device can be controlled. In order to enable high printing speeds, it is desirable to increase the throughput speed of the film through the device. For this purpose, the device has, according to the invention, a motor-operated drive roller, the rotational speed of which predetermines the throughput speed of the film through the device. The throughput speed of the film through the device can be adjusted, depending on the parameters of material properties of the film, material properties of the object, temperature of the detaching roller and of the heating roller and area of contact of the film with the heating roller.

The object stated at the outset is also achieved by a method of the type referred to at the outset having the method steps of preheating the film by means of a heating roller, adjusting the size of the area of contact of the film with the heating roller by means of an adjusting roller which is movable in at least two directions and arranged beside the heating roller, and detaching the decoration from the film, preheated by the heating roller, onto the object, and a method of the type referred to at the outset having the method steps of preheating the film by means of a heating roller, preforming the film by means of a profiled preforming roller arranged beside the heating roller, and detaching the decoration from the film, preheated by the heating roller, onto the object.

The invention is explained below by way of example with reference to the accompanying figure, in which:

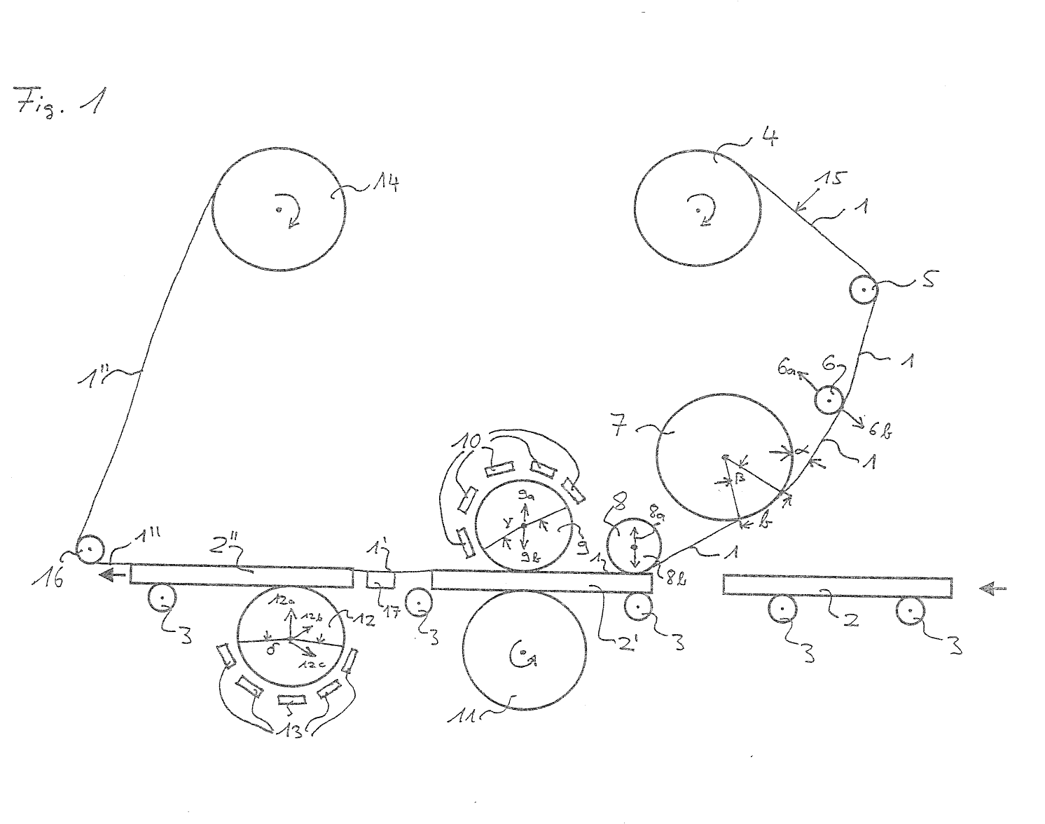

FIG. 1 shows a schematic representation of a device for applying decoration, which adheres to a film, to an object.

In the case of the device shown in FIG. 1, a film 1 with release properties passes through a device for applying decoration, which adheres to a film, to an object 2. According to preferred embodiment, the film is a so-called sandwich structure consisting of two polypropylene layers and a layer made of polypropylene foam lying therebetween. The sandwich structure is preferably produced with the aid of a coextrusion process. The film has a thickness of 50 μm. The construction of the film from polypropylene and polypropylene foam has the advantage that even at high throughput speeds through the device the film does not crease, and is nevertheless flexible.

For the release technique, use is preferably made of polypropylene, since polypropylene has a poor adhesive property and thus decoration or a colour layer can be easily detached from the film. Owing to the poor adhesive property, is however, it is difficult to apply decoration to the film. For this reason, the outer polypropylene layer of the film is subjected to a corona treatment in order to apply the decoration to the film. As a result of the corona treatment, the decoration adheres to the film, but can be detached from the film again by means of the release technique and thereby applied to the object. Preferably, the corona treatment is carried out with a surface tension energy on the surface of the film of 35 to 45 dynes. A surface tension energy of 38 dynes yields advantageous adhesive properties. As a result of such a controlled corona treatment, the film can be printed with the decoration, but the decoration still remains detachable by the release technique.

As can be seen in FIG. 1, the film 1 is wound on a winding-off roller 4. The winding-off roller 4 is mounted so as to be rotatable clockwise. The film 1 situated on the winding-off roller 4 has a decoration or a colour layer on the side 15. Optionally, a layer of lacquer (not shown) can be additionally arranged on the decoration or the colour layer. After being wound off from the winding-off roller 4, the film 1 runs over a deflection roller 5, which leads the film 1 to the adjusting roller 6. In doing so, the deflection roller 5 leads the film away from the winding-off roller 4. As can be seen in FIG. 1, the adjusting roller 6 is designed so as to be movable in two directions 6A and 6B. The adjusting roller 6 consists of metal. After the film 1 has run over the adjusting roller 6, it is fed to the heating roller 7. By movement of the adjusting roller 6 in the directions 6A or 63, the area of contact of the film 1 with the heating roller 7 can be adjusted. If, for example, the adjusting roller 6 is moved in the direction 6A, the area of contact b of the film 1 with the heating roller 7 is increased. If, however, the adjusting roller 6 is moved in the direction 6B, the size of the area of contact b of the film 1 with the heating roller 7 is reduced. By movement of the adjusting roller 6, the angle α is consequently reduced or increased, which results in a change of the central angle β or the contact area b. It is also conceivable for the adjusting roller 6 to be designed in such a way that it is movable in further directions in the plane of the figure. What is important, however, is that the adjusting roller 6 is a means for adjusting the area of contact b of the film 1 with the heating roller 6.

The heating roller 7 is fixedly arranged in the embodiment according to FIG. 1. It consists of metal and has a hollow interior space (not shown). The heating roller 7 is heated with the aid of oil heating (not shown), the heating roller delivering a temperature of 120° to 240°, preferably 180° C., to the film. Preferably, oil is used to heat the heating roller 7, since oil changes its temperature only very slowly.

After passing the heating roller 7, the film 1 is fed to the preforming roller 8. The preforming roller 8 consists of silicone foam at the surface. The preforming roller 8 is mounted so as to be movable in two directions 8A and 83 and has a negative profile of the object 2 to be printed. The purpose of the preforming roller is to prepare the film 1 for the release process, so that the film 1 does not crease or shrink even at high throughput speed of the film. At the preforming roller 8, the film 1 comes into contact for the first time with the object 2 to be printed. In the embodiment shown, a panel made of plastic 2 is to be printed with a wood decoration. The object 2 to be printed may, however, be of all kinds and shapes of materials. The object 2 is led through the device and brought into contact with the film 1 via feed rollers 3. The object 2 is additionally supported in the device by lateral rollers (not shown). After passing the preforming roller 8, the film 1 is fed to the profiled detaching roller 9.

The profiled detaching roller 9 is designed so as to be movable in two directions 9A and 9B. It consists of silicone at the surface and has at the surface a negative profile of the object 2 to be printed. The profiled detaching roller 9 is heated with the aid of five infrared radiators 10. The infrared radiators 10 are arranged over a region of the surface of the profiled detaching roller 9 which is defined by the central angle γ. In principle, it is advantageous to heat as large a region of the surface of the detaching roller 9 as possible. With the aid of the heated silicone layer of the detaching roller 9 and the pressure exerted on the film 1 and the object 2 by the detaching roller 9, the decoration, or the decoration and the layer of lacquer, is detached from the film 1 and transferred onto the object 2 with the aid of the release technique.

For machine transportation of the film 1, 1′ and of the object 2, 2′, 2″, the device has a drive roller 11. The drive roller 11 rotates anticlockwise and is operated with the aid of an electric motor. The rotational speed of the electric motor or the drive roller 11 is variably adjustable. It is thereby possible to control the throughput speed of the film 1, 1′, 1″ and of the object 2, 2′, 2″, depending on the material properties of the film 1, 1′, 1″ and of the object 2, 2′, 2″, the area of contact b of the film 1 with the heating roller 7 and the temperatures of the heating roller 7 and of the detaching roller 9. The drive roller 11 and the detaching roller 9 can be coupled via a belt (not shown), so that the detaching roller 9 can be driven with the aid of the drive roller 11 via the belt.

With the device shown in FIG. 1, it is also possible to print two sides of an object 2, e.g. a main side and an edge of the panel, with decoration and/or lacquer. For this purpose, the object 2′ and the film 1′ are fed to a detaching roller 12 movable in three directions 12A, 12B, 12C. Beforehand, the film 1′ is adapted by an adapting roller 17 to a second side of the object 2′ to be printed. The detaching roller 12 is heated in a similar manner to the detaching roller 9 by five infrared radiators 13. As a result, the decoration still situated on the film 1′ can be applied laterally to the second side of the object 2′. The detaching roller 12 consists of silicone. The infrared radiators 13 irradiate the surface of the detaching roller 12 over an area which is defined by the angle δ and the width of the detaching roller 12. After passing the detaching roller 12, the film 1″ is deflected via a deflection roller 16 and fed to a winding-up roller 14. The winding-up roller 14 rotates clockwise and winds up the film 1″. It is thus possible to print objects of multidimensional geometries, for example two sides of a panel, with decoration with the aid of only one film. According to the prior art, at least two films are required to print two sides of a panel.

Furthermore, it is advantageous in the case of the present invention that no adhesive is necessary for printing the object. The film does not crease, blister and shrink, so that high throughput speeds of the film can be achieved. In the case of the present invention, a film width of 3 cm to 60 cm is possible. In the case of known devices, only film widths of a maximum of 10 cm can technically be processed. Thus, a plurality of sides of an object can also be printed with one film. With the embodiment according to the invention, a throughput speed of the film through the device of 5 to 45 m/min is possible.

1. Device for applying decoration, which adheres to a film (1), to an object (2), having:
a heating roller (7) for preheating the film (1);
an adjusting roller (6), which is movable in at least two directions (6a, 6b) and arranged beside the heating roller (7), for adjusting the size of the area of contact (b) of the film (1) with heating roller (7); and
means (9, 10) for detaching the decoration from the film (1), preheated by the heating roller (7), onto the object (2).

2. Device according to claim 1, having a profiled preforming roller (8), arranged beside the heating roller (7), for preforming the film (1).

3. Device for applying decoration, which adheres to a film (1), to an object (2), having:
a heating roller (7) for preheating the film (1);
a profiled preforming roller (8), arranged beside the heating roller (7), for preforming the film (1); and
means (9, 10) for detaching the decoration from the film (1), preformed by the profiled preforming roller (8), onto the object (2).

4. Device according to claim 2, in which the preforming roller (8) is movable in at least two directions (8a, 8b).

5. Device according to claim 2, in which the means for detaching the decoration have a profiled detaching roller (9) for detaching the decoration from the film (1) onto the object (2) and means for heating the detaching roller (10).

6. Device according to claim 5, in which in the case of the means for heating the detaching roller (10) the temperature is variably adjustable.

7. Device according to claim 5, in which the means for heating the detaching roller (10) have at least one infrared radiator.

8. Device according to claim 5, in which the means for heating the detaching roller (10) are arranged over an area of the surface of the detaching roller (9) which is defined by a circular arc the detaching roller with a central angle (Y) of at least 160° and the width of tile detaching roller (9).

9. Device according to claim 5, in which the detaching roller (9) consists of has silicone at least at the surface.

10. Device according to claim 2, in which the preforming roller (8) consists of has silicone foam at least at the surface.

11. Device according to claim 2, in which the heating roller (7) delivers a constant temperature to the film (1).

12. Device according to claim 2, having a drive roller (11), the rotational speed of which is adjustable, so that the throughput speed of the film (1) through the device can be controlled.

13. Method for applying decoration, which adheres to a film (1), to an object (2), having at least the method steps of:
preheating the film (1) by means of a heating roller (7);
adjusting the size of the area of contact (b) of the film (1) with the heating roller (7) by means of an adjusting roller (6) which is movable in at least two directions (6a, 6b) and arranged beside the heating roller (7); and
detaching the decoration from the film (1), preheated by the heating roller (7), onto the object (2).

14. Method according to claim 13, having the method step of preforming the film (1) by means of a preforming roller (8) arranged beside the heating roller (7).

15. Method for applying decoration, which to a film (1), an object (2), having at least the method steps of:
preheating the film (1) by means of a heating roller (7);
preforming the film (1) by means of a profiled preforming roller (8) arranged beside the heating roller (7); and
detaching (9) the decoration from the film (1), preheated by the heating roller (7), onto the object (2).

16. Method according to claim 14, in which the performing roller (8) is movable in at least two directions (8a, 8b).

17. Method according to claim 13, having the method steps of heating (10) a profiled detaching roller (9) and detaching the decoration from the film (1) onto the object (2) by means of the profiled detaching roller (9).

18. Method according to claim 17, having the method step of variable adjustment of the temperature at which the profiled detaching roller (9) is heated.

19. Method according to one of claims 17 and 18, in which the detaching roller (9) is heated with the aid of least one infrared radiator (10).

20. Method according to claim 17, in which the detaching roller (10) is heated over an area of the surface of the detaching roller (9) which is defined by a circular arc of the detaching roller with a central 5 angle (Y) of at least 160° and the width of the detaching roller (9).

21. Method according to claim 13, in which the heating roller (7) delivers a constant temperature to the film (1).

22. Method according to claim 13, in which the throughput speed of the film (1) can be controlled with the aid of a drive roller (11), the rotational speed of the drive roller being adjustable.
